(19) United States
(12) Patent Application Publication
(10) Pub. No.: US 2026/0107943 A1
(43) Pub. Date: Apr. 23, 2026

(54) Process and Composition for Handling Pinoxaden Safely

(71) Applicant: ADAMA AGAN LTD., Ashdod (IL)

(72) Inventors: Vladimir GUBRIY, Ashdod (IL); David MOCATTA, Gedera (IL); Gilad SILBERT, Kibutz Dorot (IL)

(73) Assignee: ADAMA AGAN LTD., Ashdod (IL)

(21) Appl. No.: 18/872,631

(22) PCT Filed: Jun. 7, 2023
(86) PCT No.: PCT/IB2023/055854

§ 371 Date: Dec. 6, 2024

(30) Foreign Application Priority Data
Jun. 8, 2022 (EP) 22177886.3

(51) Int. Cl. A01N 43/90; A01N 25/04; A01P 13/02

(52) U.S. Cl. CPC A01N 43/90; A01N 25/04; A01P 13/02

(57) ABSTRACT

The present invention reflates to a slurry that allows to safely handle pinoxaden and is physically stable. The slurry comprises pinoxaden, its stereoisomers, salts or solvates thereof, and (ii) a solvent consisting only of a mineral oil, a vegetable oil or mixtures thereof, wherein the total weight of pinoxaden, its stereoisomers, salts or solvates thereof, with respect to the total weight of the slurry is comprised between 30 and 70 w/w %; and the weight proportion between pinoxaden, its stereoisomers, salts or solvates thereof, and the solvent is comprised between 30:70 and 70:30.

### FIELD OF THE INVENTION

The present invention relates to the field of agrochemistry and teaches a method and a composition for handling pinoxaden safely.

### BACKGROUND PRIOR ART

Pinoxaden and its herbicidal uses are disclosed in “Pesticide Chemistry. Crop Protection, Public Health, Environmental Safety” ed. H. Ohkawa et al., 2007, Wiley, Weinheim, pp. 101-110.

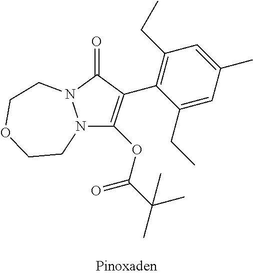 [SMILES: CCc1cc(C)cc(CC)c1-c1c(OC(=O)C(C)(C)C)n2n(c1=O)CCOCC2]

Pinoxaden is typically commercialized as an EC (emulsifiable concentrate) formulation in a mixture of hydrocarbons and alcohols at a concentration of 3-10 w/w %. See for example the safety data sheet of Axial Pro®. EC are liquid homogeneous formulations to be applied as an emulsion after dilution in water.

Powders in general can be messy and difficult to handle. They may aerosolize and enter the air, increasing the risk of inhalation by workers. This is critical when designing processes that involve the use of pinoxaden, which must be handled with care due to its toxicity. Special safety equipment and procedures are required because powders can enter the respiratory system. Safe handling of pinoxaden typically requires specially designed facilities from the moment it is synthesized or enters the formulation site, throughout the process up to packaging of the ready-to-use formulation. This also makes the transportation and storage of pinoxaden complicated and involves high investments in terms of time and money. This is an issue that has not been addressed in the prior art.

CN 102 283 217 discloses in example 9 an oil suspension comprising: florasulam 20%, pinoxaden 30%, polycarboxylate 5%, lignosulfonates 4%, silicone defoamer 0.3%, aluminium-magnesium silicate 1%, phenyl phenol polyoxy ethyl ether phosphate 5%, and vegetable oil about 35%.

CN 105 660 665 discloses in example 7 an oil suspension comprising: 35% pinoxaden, 15% pyroxsulam, 7% florasulam, 6% sodium polycarboxylate, 19% mixture of surfactants, 0.5% bentonite, 6% propylene glycol and 12.5% wheat oil, wherein the weight proportion pinoxaden:wheat oil is 35:12.5 (70:25).

IN 2018-21039248 discloses a process for obtaining crystalline pinoxaden (Form G) comprising a) dissolving pinoxaden in a fluid medium under stirring, at a temperature in the range of 30 to 75 C to obtain a solution comprising pinoxaden; b) crystallizing pinoxaden in said solution, by cooling said solution to a temperature in the range of 10 to 25 C, over a time period in the range of 5 to 12 hours to obtain a slurry comprising crystals of pinoxaden form G; and c) isolating said crystalline pinoxaden form G from the slurry. In example 1 pinoxaden (5 g) is dissolved in o-xylene (10 g). IN 2018-21039248 is silent about the stability of such slurry, and directly isolates pinoxaden form G.

WO 2021/009716 discusses the chemical stability of pinoxaden in the presence of solvents having different pH values a water contents. The examples discuss the chemical stability of pinoxaden in different solvents at concentrations of 5 to 7 w/w %. This document is silent on the physical stability of such mixtures.

There is therefore a need to provide efficient processes and/or equipment to handle pinoxaden safely. There is also a need to provide a technical pinoxaden form that can be stable for long periods of time.

### SUMMARY OF THE INVENTION

The inventors have discovered a surprisingly efficient and simple way to handle pinoxaden and reduce hazards in its handling, storage and transportation. This is achieved by preparing a slurry of pinoxaden and an oil. The slurry had to be physically stable for enough time to be mixed later with the final components of a formulation. The solvent had to allow sufficient concentration of pinoxaden for an economic storage and transportation of pinoxaden. Thus, a first aspect of the invention is a physically stable slurry comprising (i) pinoxaden, its stereoisomers, salts or solvates thereof, and (ii) a solvent consisting only of a mineral oil, a vegetable oil or mixtures thereof, wherein
the total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30.

Preferably, the solvent has a water content of 3.0 w/w % or less, measured by Karl Fischer, with respect to the total weight of the solvent.

Slurries in general tend to form “hard heels”, that is, a sediment that resist resuspension that is difficult to remove from the equipment and can clog lines. However, the slurries disclosed herein are easy to prepare, can be stored for long periods (e.g., 3, 4 months) of time and can be easily re-suspended by simply stirring the slurry. Thus, even if some caking was observed at high concentrations, all the slurries according to the invention could be resuspended into stable slurries. The slurry disclosed herein is surprisingly stable and removes or at least greatly reduces the hazards of pinoxaden. The slurry reduces the risks for those handling pinoxaden and greatly reduces the investment in specific facilities. Hazardous solids require specifically dedicated facilities and extreme security measures to guaranty the safety of workers. The slurry disclosed herein is unexpectedly stable for at least 8 weeks at room temperature (25° C.) and/or for at least 2 weeks at 54° C., and represents a simply an efficient solution, and an alternative to expensive facilities.

Accordingly, a further aspect of the invention is a method for the preparation of the slurry of the invention comprising mixing pinoxaden, its stereoisomers, salts or solvates thereof, with a solvent consisting only of a mineral oil, a vegetable oil or mixtures thereof, wherein
the total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30.

Preferably, the solvent has a water content of 3.0 w/w % or less, measured by Karl Fischer, with respect to the total weight of the solvent.

No caking or precipitation is observed after long periods in storage, even in the absence of emulsifiers, surfactants, rheological modifiers and/or anti-cacking agents. The slurry can be easily re-suspended by stirring, if necessary, even after long periods of storage, and can be used to prepare final agrochemical formulations comprising pinoxaden without the hazards of handling solid pinoxaden.

Therefore, another aspect of the invention is a method for storing pinoxaden, its stereoisomers, salts or solvates thereof, comprising mixing pinoxaden, its stereoisomers, salts or solvates thereof, with a solvent consisting only of a mineral oil, a vegetable oil or mixtures thereof, wherein
the total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30.

Preferably, the solvent has a water content of 3.0 w/w % or less, measured by Karl Fischer, with respect to the total weight of the solvent.

A further aspect is a method of re-suspending the slurry disclosed herein comprising stirring said slurry after a period of storage.

The slurry disclosed herein can be stored and transported safely, and used to prepare final formulations containing pinoxaden. It is therefore another aspect of the invention a method for the preparation of an agrochemical formulation comprising the step of mixing the slurry disclosed herein with at least one agrochemical acceptable active ingredient and/or an agrochemical acceptable additive.

Further aspects of the invention are
The use of the slurry disclosed herein for the preparation of an agrochemical formulation.
The use of the slurry disclosed herein for storing pinoxaden.
The use of the disclosed herein to prevent or reduce toxicity of pinoxaden.
The use of the slurry disclosed herein to prevent or reduce inhalation of pinoxaden.

### DETAILED DESCRIPTION OF THE INVENTION

### Definitions

In the present document the following terms are given the meaning below.

A physically stable slurry according to the present disclosure is one that can be redispersed after storage for at least 8 weeks at room temperature (25° C.) or for at least 2 weeks at 54° C., and then mixed with other ingredients for the preparation of a formulation. That is, the present application is concerned with the physical stability of the slurry, rather than the chemical stability of pinoxaden. The inventors have observed that the particles of pinoxaden in the slurry do not form “hard heels” at the bottom of the containers, and do not either seem to irreversibly coagulate or flocculate.

“Agrochemical acceptable” refers to any molecular entity or composition that is used in the formulation of the invention to improve any of its properties, such as any chemical, biological or physico-chemical properties approved for use agrochemistry by a regulatory agency or a state government or other generally recognized pharmacopeia.

The disclosure also provides salts of the compounds herein defined. For instance, salts of compounds provided herein may be acid addition salts, base addition salts or metallic salts, and they can be synthesized from the parent compound which contains a basic or acidic moiety by conventional chemical methods. Generally, such salts are, for example, prepared by reacting the free acid or base forms of these compounds with a stoichiometric amount of the appropriate base or acid in a solvent. Generally, non-aqueous media like ether, ethyl acetate, ethanol, isopropanol or acetonitrile are preferred. Examples of the acid addition salts include mineral acid addition salts such as, for example, hydrochloride, hydrobromide, hydroiodide, sulphate, nitrate, phosphate, and organic acid addition salts such as, for example, acetate, maleate, fumarate, citrate, oxalate, succinate, tartrate, malate, mandelate, methanesulphonate and p-toluenesulphonate. Examples of the alkali addition salts include inorganic salts such as, for example, ammonium, and organic alkali salts such as, for example, ethylenediamine, ethanolamine, N,N-dialkylenethanolamine, triethanolamine, glucamine and basic aminoacids salts. Examples of the metallic salts include, for example, sodium, potassium, calcium, magnesium, aluminium and lithium salts.

The term “solvate” according to this disclosure is to be understood as meaning any form of the compound which has another molecule (most likely a polar solvent) attached to it via non-covalent bonding. Examples of solvates include hydrates and alcoholates, e.g. methanolate.

An “stereoisomer” in the present patent application refers to compounds made up of the same atoms bonded by the same sequence of bonds but having different three-dimensional structures which are not interchangeable.

### Slurry

The slurry disclosed herein can be easily prepared by mixing pinoxaden, its stereoisomers, salts or solvates thereof and the solvent. Stirring can be done with standard low shear or medium shear equipment, or with high shear stirrers. Also, it can be a combination of both, for example, by performing first a low shear mixing and then a high shear mixing. The slurries obtainable by such methods are also an aspect of the present disclosure. The solvent can be any mineral or vegetable oil (or combination of both), preferably having a water content of 3.0 w/w % or less, measured by Karl Fischer, with respect to the total weight of the solvent. No other solvents are included in the slurry.

In order to form a slurry according to the present disclosure, the amount of pinoxaden, its stereoisomers, salts or solvates thereof, must be high. This will avoid stability problems and also have the advantage of reducing the volume needed for any given amount of pinoxaden. For example, the amount of pinoxaden, its stereoisomers, salts or solvates thereof, is between 30 w/w % and 70 w/w %, or between more than 30 w/w % and 70 w/w % or between 32 w/w % and 70 w/w %, or between 33 w/w % and 70 w/w %, or between 34 w/w % and 70 w/w %, or between 35 w/w % and 70 w/w %, or between 40 w/w % and 70 w/w %, or between 45 w/w % and 70 w/w %, with respect to the toral weight of the slurry. For example, between 30 w/w % and 65 w/w %, or between 30 w/w % and 60 w/w %, or between 30 w/w % and 55 w/w % or between more than 30 w/w % and 55 w/w % or between 32 w/w % and 50 w/w % or between 33 w/w % and 50 w/w % or between 31 w/w % and 48 w/w % or between 35 w/w % and 55 w/w % or between 35 w/w % and 45 w/w %, with respect to the total weight of the slurry. Preferably, pinoxaden its stereoisomers, salts or solvates thereof is the only active ingredient present in the slurry.

At the same time, the weight proportion between pinoxaden, its stereoisomers, salts or solvates thereof, and the solvent is comprised between 30:70 and 70:30. For example, the weight proportion between pinoxaden, its stereoisomers, salts or solvates thereof, and the solvent is comprised between 35:65 and 65:35 or between 40:60 and 60:40 or between 45:55 and 55:45. The particle size of pinoxaden, its stereoisomers, salts or solvates thereof, is not particularly relevant, although smaller particle size is preferred. For example, the particle size D90 of pinoxaden, its stereoisomers, salts or solvates thereof, is 800 microns or less, preferably 700 microns or less, preferably 600 microns or less, preferably 500 microns or less, preferably 400 microns or less.

It is preferred that the slurry contains only pinoxaden, its stereoisomers, salts or solvates thereof, and the solvent, and, optionally, a biocide and/or an antioxidant to avoid chemical and biological degradation, typically added in small amounts, for example 5 w/w % or less, preferably 4 w/w % or less, preferably 3 w/w % or less, preferably 2 w/w % or less, preferably 1 w/w % or less, with respect to the total weight of the slurry. The slurries disclosed herein do not require any other additives to maintain stability through long periods of storage or during transportation. Therefore, the slurries disclosed herein may contain no rheological modifiers at all (also known as thickeners or viscosity modifiers), for example, no rheological modifiers such as those selected from the group consisting of montmorillonite (e.g. bentonite), magnesium aluminum silicate, attapulgite, polysaccharides (e.g. gums, such as xanthan gum), castor oil derivatives, alkali-acrylic emulsions, polyurea, Silicon dioxide, polyamides, calcium sulfonates, alkali swellable emulsions (ASE), hydrophobically modified alkali swellable emulsion (HASE), hydrophobically modified ethoxylated urethane resin (HEUR) and hydroxyethyl cellulose (HEC).

Further, the slurries disclosed herein may contain no anti-cacking agents at all, for example, no anti-cacking agents such as those selected from the group consisting of tricalcium phosphate, powdered cellulose, magnesium carbonate, iron ammonium citrate, magnesium stearate, sodium bicarbonate, sodium ferrocyanide, potassium ferrocyanide, calcium ferrocyanide, bone phosphate (i.e. calcium phosphate), sodium silicate, silicon dioxide, calcium silicate, magnesium trisilicate, talcum powder, sodium aluminosilicate, potassium aluminium silicate, calcium aluminosilicate, bentonite, aluminium silicate, stearic acid and polydimethylsiloxane.

Further, the slurries disclosed herein may contain no emulsifiers or surfactants at all, for example, no emulsifiers or surfactants, whether ionic or non-ionic surfactants, such as those selected from the group consisting of polyalcoxylated alcohols (e.g. esters of polyalkoxylated polyols, polyalkoxylated polyols, or polyalkoxylated aliphaitic alcohols), aliphatic or aromatic sulphates, sulphonates (sulfonates) or phosphates (e.g. alkyl sulphonates [for example, dodecylbenzene sulfonate or ammonium dodecylbenzene sulfonate], alkyl aryl sulphonates, aryl alkyl sulphonates, aryl sulphonates, alkyl phosphates, alkyl aryl phosphates, aryl alkyl phosphates, aryl phosphates) or their salts, nonylphenoxy polyethylenoxy alcohols, ethylene oxide/propylene oxide block copolymers, polyalkoxylated fatty acids (e.g., ethoxylated castor oils, ethoxylated castor oil esters such as Atlas G-1086® or polyoxyethylene hydrogenated castor oil), sorbitan esters, sorbitan fatty acid ester ethoxylates, sorbitol ethoxylate esters, polyalkoxylates alkylphenols, polyalkoxylated block copolymers (like Atlas G-5000®), polycarboxylates, sulfosuccinates (eg. dioctylsulfosuccinate), methyl oleyl taurates, ethoxylated alcohol phosphate esters, ethoxylated fatty amines, ethoxylated tristyrylphenols, etho-propoxylated tristyrylphenols, ethoxylated tristyrylphenol phosphates, ethoxylated tristyrylphenols sulphates, ethoxylated distyrylphenols sulphates, alkylnaphtalene sulphonates, condensed alkylpaphtalene sulphonates, alkylpolysaccharides, amine alkylbenzenesulfonates, polyalkylene oxide block copolymers, alkoxylated ethylene diamines, ethoxylated triglycerides, polyoxyalkylene lanolin, styrene acrylic polymer, sarcosinates, sodium lignosulfonates.

For example, the slurries disclosed herein may contain no rheological modifiers, no anti-cacking agents and/or no emulsifiers nor surfactants, preferably, the slurry contains no rheological modifiers, no anti-cacking agents, no emulsifiers and no surfactants.

### Solvent

The solvent used in the slurry is a mineral oil or an oil of vegetable or a mixture of both. The vegetable oil can be, for example, coconut oil, corn oil, cottonseed oil, palm oil, canola oil, rapeseed oil, olive oil, sunflower oil, peanut oil, sesame oil, soybean oil or mixtures thereof. Other derivatives of vegetable oils are also within the scope of the present disclosure, such as, an emulsified vegetable oil, or an alkyl ester of an oil of vegetable origin such as, for example, the methyl or ethyl ester derivatives. For the purposes of the present invention canola oil, rapeseed oil, sunflower oil, or soybean oil or mixtures thereof are preferred. Although mixtures of different solvents having the required water content are within the scope of the present disclosure, a single solvent is preferable for practical reasons, for example, canola oil, rapeseed oil, sunflower oil, or soybean oil, preferably, canola oil.

Mineral oils having the required water content are also solvents within the scope of the present disclosure, whether aromatic or non-aromatic. The mineral oils can be paraffinic, isoparaffinic, cycloparaffinic, naphthenic or aromatic. Mineral oils of particular interest in the present disclosure are hydrotreated light paraffinic distillate (also known as white spirit, light mineral oil or white mineral oil), such as the Marcol™ series (e.g. Marcol™ 52 or Marcol™ 82), alkylbenzenes and spindle oils or a mixture thereof. Further mineral oils of particular interest in the present disclosure are hydrotreated light paraffinic distillate (also known as white spirit, light mineral oil or white mineral oil), such as the Marcol™ series (e.g. Marcol™ 52 or Marcol™ 82), and spindle oils or a mixture thereof. Also within the scope of the present disclosure are aromatic oils such as ExxonMovil™ Aromatic 100, ExxonMovil™ Aromatic 150 ND, ExxonMovil™ Aromatic 200, ExxonMovil™ Aromatic 200 ND, ExxonMovil™ Aromatic 200 ULN, ExxonMovil™ Solvent Naphtha H, Solvesso™ 100, Solvesso™ 150, Solvesso™ 150 ND, Solvesso™ 200, or Solvesso™ 200ND. Further preferred mineral oils are paraffins, such as isoparaffins. Exemplary isoparaffins comprise C₈-C₂₅, for example C₁₀-C₂₀-isoalkanes, i.e. alkanes comprising mostly linear molecules with a methyl group in one of its penultimate carbon atoms to form a —C(H)(CH₃)₂ residue. It is for example preferred that the mineral oil is an isoparaffinic oil comprising at least 20 w/w % of C₁₄-C₁₉-isoalkanes, with respect to the total weight of the oil, and less than 2 w/w % of aromatic compounds, with respect to the total weight of the oil.

The solvent preferably has a low water content, specifically of 3.0 w/w % or less, measured by Karl Fischer, with respect to the total weight of the solvent. Lower amounts of water content are preferred, for example 2.5 w/w % or less, preferably 2.0 w/w % or less, preferably 1.5 w/w % or less, preferably 1.0 w/w % or less, preferably 0.8 w/w % or less, preferably 0.7 w/w % or less, preferably 0.6 w/w % or less, preferably 0.5 w/w % or less, preferably 0.4 w/w % or less, preferably 0.3 w/w % or less, preferably 0.2 w/w % or less, preferably 0.15 w/w % or less, preferably 0.1 w/w % or less, preferably 0.05 w/w % or less measured by Karl Fischer, with respect to the total weight of the solvent. Preferably, the water content in the solvent is such that pinoxaden does not hydrolyze significantly, for example, such an amount that less than 5 w/w % of pinoxaden, its stereoisomers, salts or solvates thereof decomposes after 2 weeks at 54° C. in a slurry having 30 w/s % of pinoxaden, a stereoisomer, a salt or solvate thereof.

The pH of the solvent as measured according to the process defined below, is preferably 5.0 or more, or 5.5 or more, or 5.8 or more, typically between 5.0 and 10.0, or between 5.5 and 9.0, or between 5.5 and 8.0, for example, between 5.5 and 7.8, or between 5.6 and 7.6, or between 5.8 and 7.5. The pH is measured by a process consisting of the steps of
a) making a deionized water mixture having 1 w/w % of solvent;
b) stirring the mixture of the previous step with a magnetic stirrer at 1,500 RPM for 10 minutes at 25° C.;
c) allowing the phases in the mixture to separate for 10 min at 25° C.,
d) collecting into a separate vial the lower aqueous phase;
e) measuring at 25° C. the pH of aqueous phase collected using a JENWAY 3510 PH meter, with an AgCl, liquid filled single junction electrode, such that the electrode and the thermocouple of the pH meter are inserted into the vial containing the aqueous water phase until the measured pH value is stable for 10 s.

The slurry of the invention can therefore be a physically stable slurry comprising (i) pinoxaden, its stereoisomers, salts or solvates thereof, and (ii) a solvent consisting only of a mineral oil, a vegetable oil or mixtures thereof, wherein
the total weight of pinoxaden, its stereoisomers, salts or solvates thereof, with respect to the total weight of the slurry is comprised between more than 30 and 70 w/w %; and
the weight proportion between pinoxaden, its stereoisomers, salts or solvates thereof, and the solvent is comprised between 30:70 and 70:30; and
   wherein the solvent has a water content of 3.0 w/w % or less, measured by Karl Fischer, with respect to the total weight of the solvent.

Alternatively, the slurry of the invention can be a physically stable slurry comprising (i) pinoxaden, its stereoisomers, salts or solvates thereof, and (ii) a solvent consisting only of a vegetable oil (e.g. canola oil) or mixtures of vegetable oils, wherein
the total weight of pinoxaden, its stereoisomers, salts or solvates thereof, with respect to the total weight of the slurry is comprised between more than 30 and 70 w/w %; and
the weight proportion between pinoxaden, its stereoisomers, salts or solvates thereof, and the solvent is comprised between 30:70 and 70:30; and
   wherein the solvent has a water content of 3.0 w/w % or less, measured by Karl Fischer, with respect to the total weight of the solvent.

Alternatively, the slurry of the invention can be a physically stable slurry consisting of (i) pinoxaden, its stereoisomers, salts or solvates thereof, (ii) a solvent consisting only of a mineral oil, a vegetable oil or mixtures thereof, and (iii) less than 10 w/w %, preferably less than 5 w/w % of a biocide and or antioxidant, wherein
the total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30; and
   wherein the solvent has a water content of 3.0 w/w % or less, measured by Karl Fischer, with respect to the total weight of the solvent. Such slurry therefore contains no elements other than (i), (ii) and (iii) listed above, and specifically contains no emulsifiers, surfactants, anti-cacking agents nor rheology modifiers.

### Co-Herbicides

The slurry disclosed herein typically comprises no other co-herbicides and preferably only consists of pinoxaden, its stereoisomers, salts or solvates thereof, and the solvent. However, the slurry can include co-herbicides, for example, if it is going to be used to prepare formulations containing a further herbicide in addition to pinoxaden.

The slurries herein disclosed may thus comprise at least one co-herbicide, for example one selected from the group consisting of ALS inhibitors such as sulphonylureas (e.g. mesosulfuron), sulphonyl-carbonyl-triazolinones, imidazolinones, triazolopyrimidines or pyrimidinyl (thio) benzoates; inhibitors of the photosynthesis at PS II such as nitriles, phenyl-pyridazines, benzothiadiazinones, triazines, triazolinones or triazinones; PS-I-electron diversion such as bipyridyliums; protoporphyrinogen oxidase inhibitors, such as diphenyl ethers, thiadiazoles, pyrmidinediones, N-phenyl-phthalimides, oxazolidinediones, tiazolinones, oxadiazoles or phenypyrazoles; PDS inhibitors; 4-HPPD inhibitors; DOXP synthase inhibitors and other pigment synthesis inhibitors; EPSP synthase inhibitors; glutamine synthase inhibitors; DHP inhibitors; microtubule assembly inhibitors; microtubule organization inhibitors; VLCFA inhibitors; inhibitors of the synthesis of cellulose; membrane disruptors (uncouplers); non-ACCase inhibitors of lipid synthesis; synthetic auxins; or auxin transport inhibitors.

Herbicides that can be used as co-herbicides in the present disclosure can be for example amidosulfuron, azimsulfuron, bensulfuron-methyl, chlorimuron-ethyl, cinosulfuron, chlorsulfuron, chlorimuron, cyclosulfamuron, ethametsulfuron-methyl, ethoxysulfuron, fluazasulfuron, flupyrsulfuron, imazosulfuron, iodosulfuron, mesosulfuron-metsulfuron-methyl, nicosulfuron, oxasulfuron, primisulfuron, pyrazosulfuron-ethyl, sulfosulfuron, rimsulfuron, imazamox, imazapyr, pyrithiobac-sodium, pyriminobac, bispyribac-sodium, atrazin, butracil, simazin, simethryne, terbutryne, terbuthylazine, trimexyflam, isoproturon, chlortoluron, diuron, dymron, fluometuron, linuron, methabenzthiazuron, glyphosate, sulfosate, glufosinate, nitrofen, bifenox, acifluorfen, lactofen, oxyfluorfen, ethoxyfen, fluoroglycofen, fomesafen, halosafen, azafenidin, benzfendizone, butafenacil, carfentrazone-ethyl, cinidon-ethyl, flumichlorac-pentyl, flumioxazin, fluthiacet-methyl, oxadiargyl, oxadiazon, pentoxazon, sulfentrazone, fluazolate, pyraflufen-ethyl, alachlor, acetochlor, butachlor, dimethachlor, dimethenamid, S-dimethenamid, metazachlor, metolachlor, S-metolachlor, pretilachlor, propachlor, propisochlor, thenylchlor, pethoamid, 2,4-D, fluroxypyr, MCPA, MCPP, MCPB, trichlorpyr, mecropop-P, hexazinon, metamitron, metribuzin, oryzalin, pendimethalin, trifluralin, chloridazon, norflurazon, chlorpropham, desmedipham, phenmedipham, propham, mefenacet, fluthiacet, butylate, cycloate, diallate, EPTC, esprocarb, molinate, prosulfocarb, thiobencarb, triallate, fentrazamide, cafenstrole, dicamba, picloram, diflufenican, propanil, bromoxynil, dichlobenil, ioxynil, sulcotrione, mesotrione, isoxaflutole, isoxachlortole, flucarbazone, propoxycarbazone (or its sodium salt), foramsulfuron, penoxsulam, trifloxysulfuron (or its sodium salt), pyriftalid, trifloxysulfuron (or its sodium salt), pyriftalid, flufenpyr-ethyl, profluazol, pyraclonil, benfluamid, picolinafen, amicarbazone, flufenpyr-ethyl, profluazol, pyraclonil, benfluamid, picolinafen, amicarbazone, chlorasuiam, diclosulam, florasulam, flumetsulam, metosulam, amitrol, benfuresate, bentazone, cinmethylin, clomazone, chlopyralid, difenzoquat, dithiopyr, ethofumesate, flurochloridone, indanofane, isoxaben, oxaziclomefone, pyridate, pyridafol, quinchlorac, quinmerac, tridiphane and flamprop.

Preferably, the co-herbicide is an ALS inhibitor, such as a sulphonylurea.

Sulphonylureas are a well know family of ALS inhibitors with numerous examples in the pesticide industry. For example, Triasulfuron, tribenuron-methyl, iodosuifuron-methyl (as the sodium salt), mesosulfuron-methyl, and pyroxsulam are disclosed in “The Pesticide Manual, ed. C. D. S. Tomlin, 15th edition, 2009, British Crop Production Council, UK, see entry 494 “iodosulfuron-methyl-sodium” (pp. 658-660), entry 550 “mesosulfuron-methyl” (pp. 733-734), entry 753 “pyroxsulam” (pp. 1001-1002), entry 868 “triasulfuron” (pp. 1150-1151), and entry 873 “tribenuron-methyl” (pp. 1156-1158).

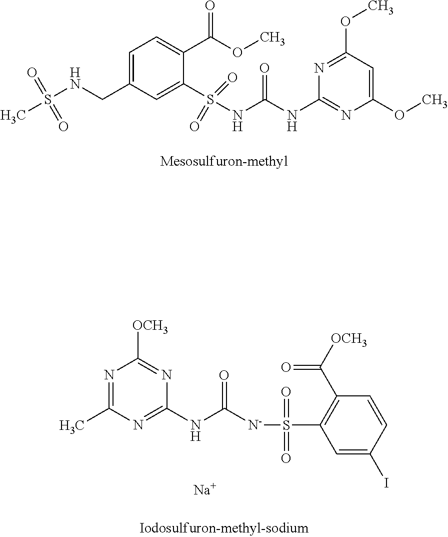

Preferably, the sulphonylurea herbicide is one selected from the group consisting of amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron and alkyl ethers or esters thereof, as well as salts thereof.

Combinations of pinoxaden and structural derivatives thereof together with sulphonylureas are known in the art. WO 2011/107741 A1 discloses herbicidal compositions comprising a mixture of (a) an ALS inhibitor in the form of an aluminum salt and (b) pinoxaden.

The co-herbicide, preferably a sulphonylurea, can be present in a wide range of concentrations, typically, in an amount from 0.01 to 95 w/w %, typically from 0.1 to 50 w/w %, for example, from 0.2 to 25 w/w %, or from 0.5 to 20 w/w %. Said co-herbicides can even be in lower amounts, for example, between 0.01 and 15 w/w %.

### Formulations

The slurries of the present disclosure are used to prepare formulations that will later be applied at the locus of the weeds after being diluted or without prior dilutions (tank mixtures). The formulations that can be prepared using this slurry can be essentially any formulation containing an oil or organic solvent, such as, oil-miscible liquids (OL), dispersible concentrates (DC), emulsifiable concentrates (EC), emulsions (EW), micro-emulsions (ME), aqueous capsule suspensions (CS), oil-based suspension concentrates (OD), mixed formulations of CS and SC (ZC), mixed formulations of CS and EW (ZW), mixed formulations of CS and SE (ZE). Such formulations are prepared following known methods by mixing the slurry with one or more agriculturally acceptable additives commonly used in the field of agrochemistry, such as wetting agents, adjuvants, adhesives, neutralizers, antifoams, for example silicone oil, sequestrates, fertilizers, preservatives or biocides, viscosity regulators, binders, tackifiers, thickeners, stabilizers, buffers or anti-freeze agents, or surfactants, amongst others. Typical additives that can be used in such formulations are for example disclosed in WO 2013/021229. The formulations are prepared in a known manner, for example by intimately mixing and/or grinding the slurry and one or more agriculturally acceptable additives.

Said agriculturally acceptable additives are known in the art and the skilled person can find numerous examples in the literature. For examples, McCutcheon's, “Detergents and Emulsifiers Annual”, MC Publ. Corp., Ridgewood NJ.; or Sisley and Wood, “Encyclopedia of Surface Active Agents”, Chem. Publ. Co. Inc., N.Y. 1964; provide detailed examples of surfactants that can be useful. Surfactants can be anionic surfactants of the dodecylbenzylsulfonate type (alkyl benzene sulfonate salts such as Nansa EVM 70/2E), especially the calcium salts thereof, and also non-ionic surfactants of the fatty alcohol ethoxylate type. Examples of commercially available surfactants are the Genapol types (Clariant AG, Muttenz, Switzerland). Typical surfactants can also be selected from the group consisting of polyacrylate graft copolymers (e.g. Dispersogen PSL 100), phosphated alcohol ethoxylates (e.g. Hostaphat 1306) and star structure polymers (e.g. Atlox 4916). The concentration of the surface-active substances in such formulations is generally from 1 to 30 w/w %, preferably between 2 and 10 w/w %.

The antifoams or defoamers useful in such formulations can be selected from the group consisting of silicon oil, polyethylene glycol polypropylene glycol copolymers and alkyl polyacrylates.

The thickeners useful in such formulations can be selected from the group consisting of organically-derived hectorite clay (e.g. Bentone 38), polyester block co-polymer (e.g. Atlox Rheostrux 100), organically-derived silica (e.g. Aerosil R816).

### EXAMPLES

### Example 1

Pinoxaden was mixed with a canola oil containing less than 0.3 w/w % of water under different stirring regimes, and then stored under different conditions. Then, viscosity (in some cases), re-dispersability and caking was checked. The results are shown below in Table 1.

TABLE 1

| | Pinoxaden | | | | Viscosity, (cP) | | Caking |
|---|---|---|---|---|---|---|---|
| Sample | Content | Oil | Mixing | | before | | after |
| Number | (w/w %) | w/w % | Type | Storage | redispersion | Redispersibility | storage |
| 1 | 50 | 50 | Mixing | 7 weeks | 6,000-10,000 | Easy | None |
| | | | and High | at RT | | | |
| | | | Shear | | | | |
| 2 | 50 | 50 | Mixing | 2 weeks | NA | Easy | None |
| | | | and High | at 54° C. | | | |
| | | | Shear | | | | |
| 3 | 50 | 50 | Mixing | 8 weeks | NA | Easy | None |
| | | | only | at RT | | | |
| 4 | 50 | 50 | High | 8 weeks | NA | Easy | None |
| | | | Shear | at RT | | | |
| | | | only | | | | |
| 5 | 50 | 50 | No | 8 weeks | 20,000+ | Difficult | None |
| | | | mixing-oil | at RT | | | |
| | | | added to | | | | |
| | | | Pinoxaden | | | | |
| 7 | 35 | 65 | High | 8 weeks | 4,500 | Easy | None |
| | | | Shear only | at RT | | | |

Similar results were obtained when storing a mixture of pinoxaden and the same canola oil in 36 L drums (60 cm tall) for 2 months at room temperature. No cacking was observed, and the slurry was readily re-dispersible.

### Example 2

Pinoxaden was mixed with a canola oil containing less than 0.3 w/w % of water at different concentrations. Then, viscosity, redispersibility, and caking was checked after two weeks at room temperature. The results are shown below in Table 2.

TABLE 2

| | | | | |
|---|---|---|---|---|
| Pinoxaden (w/w %) | 30 | 45 | 60 | 65 |
| Cacking | No | No | No | No |
| Viscosity | 2000 | 2500 | 2700 | 42000 |
| Redispersability | Yes | Yes | Yes | Yes |

Although some caking was observed after 2 weeks at 54° C. or after 8 weeks at 40° C., the slurry was readily redispersed to a physically stable slurry.

1. A physically stable slurry comprising (i) pinoxaden, its stereoisomers, salts or solvates thereof, and (ii) a solvent consisting only of a mineral oil, a vegetable oil or mixtures thereof, wherein
The total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30.

2. The slurry according to claim 1, comprising no emulsifiers, surfactants, anti-cacking agents nor rheology modifiers.

3. The slurry according to any of claim 1 or 2 consisting of pinoxaden, its stereoisomers, salts or solvates thereof, and the solvent, and optionally a biocide and/or an antioxidant.

4. The slurry according to any of the previous claims, wherein the weight proportion between pinoxaden, its stereoisomers, salts or solvates thereof, and the solvent is comprised between 40:60 and 60:40.

5. The slurry according to any of the previous claims, wherein the solvent is a hydrotreated light paraffinic distillate.

6. The slurry according to any of claims 1 to 4, wherein the solvent consists of canola oil.

7. A method for the preparation of the slurry defined in any of claims 1 to 6 comprising mixing (i) pinoxaden, its stereoisomers, salts or solvates thereof, with (ii) a solvent consisting only of a mineral oil, a vegetable oil or mixtures thereof, wherein
the total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30.

8. The method according to claim 7, comprising a first low shear mixing and then a high shear mixing.

9. A method for storing pinoxaden, its stereoisomers, salts or solvates thereof, comprising mixing (i) pinoxaden, its stereoisomers, salts or solvates thereof, with (ii) a solvent consisting only of a mineral oil, a vegetable oil or mixtures thereof, wherein
the total weight of pinoxaden, its stereoisomers, salts or solvates thereof, with respect to the total weight of the slurry is comprised between 30 and 70 w/w %; and
the weight proportion between pinoxaden, its stereoisomers, salts or solvates thereof, and the solvent is comprised between 30:70 and 70:30.

10. A method of re-suspending the slurry defined in any of claims 1 to 6, comprising stirring said slurry.

11. A method for the preparation of an agrochemical formulation comprising the step of mixing the slurry defined in any of claims 1 to 6 with at least one co-herbicide and/or an agrochemical acceptable additive.

12. Use of the slurry defined in any of claims 1 to 6 to prevent or reduce inhalation of pinoxaden.

13. Use of the slurry defined in any of claims 1 to 6 for storing pinoxaden.

14. Use of the slurry defined in any of claims 1 to 6 for preparing an agrochemical formulation.

15. Use of the slurry defined in any of claims 1 to 6 to prevent or reduce toxicity of pinoxaden.
